(19) United States
(12) Patent Application Publication
(10) Pub. No.: US 2005/0125195 A1
(43) Pub. Date: Jun. 9, 2005

(54) Method, apparatus and sofware for network traffic management

(76) Inventor: Juergen Brendel, North Shore City (NZ)

Correspondence Address: WILMER CUTLER PICKERING HALE AND DORR LLP, 60 STATE STREET, BOSTON, MA, 02109, US

(21) Appl. No.: 10/499,766

(22) PCT Filed: Dec. 23, 2002
(86) PCT No.: PCT/NZ02/00291

(30) Foreign Application Priority Data
Dec. 21, 2001 (NZ) 516346

(51) Int. Cl. G21C 17/00; G06F 11/30

(52) U.S. Cl. 702/182

(57) ABSTRACT

A network traffic evaluation device is provided that may be used to warn of or prevent trafficabnormalities such as denial of service attacks. The device includes a data interface to receive one or both of network traffic and data indicative of characteristics f network traffic. The network traffic and/or data received by the data interface is processed for predeterminedcharacteristics that indicate that the network traffic contains a subset of attack traffic. Upon detection of the predetermined characteristics information defining a superset is provided. The superset is a portion of the network traffic that contains the subset and defines network traffic that may be redirected and/or blocked by a network device.

### TECHNICAL FIELD

This invention relates to a method, apparatus and/or software product for the management of network traffic. More particularly, but not exclusively, the present invention may have application to the management of network conditions indicative of a denial of service attack of some form and may also have application to the management of attacks on a network such as the receipt of viruses, worms and signature based attacks.

### BACKGROUND

As networks grow in size and interconnectivity, the activities of network security and bandwidth management are becoming increasingly difficult. Attacks on a network may come from various sources, ranging for example from the-professional hacker, dissatisfied customer or associate, internally, or from the generally mischievous. Although identification of the attacker is an important aspect of security management, a primary goal of most businesses is to preserve continued operation of their network, so as to not interfere with the operational capabilities of the business. Continued reliable operation of a network may be particularly important for Internet-based businesses or businesses which operate using one or more intranets.

Firewalls, filters and the like in combination with passwords have been traditionally used to protect against unauthorised access to confidential or private information.

An alternative form of attack on a network is a denial of service (DoS) attack. A DoS attack may be directed at mission critical web sites, network installations, network devices, and servers for various reasons.

A first kind of DoS attack is aimed at particular weaknesses in a server's or router's operating system. A specific packet or command can crash or disable the device. Usually, the manufacturer of the device will produce a patch immediately after the problem becomes known. Thus, defences against these attacks are usually readily available. Additionally, Intrusion Detection Systems (IDS) are geared to detect any attempt to gain access to a computer or other network device by unauthorised users. Thus, solutions to these kinds of attacks exist.

A flood-style DoS attack is an attack against the resources, for example network bandwidth, attempting to deplete this resource, rather than an attempt to gain access into a particular system. Most commonly, such an attack consists of flooding the victim with massive amount of network traffic, often simply junk packets with fake source addresses. “Flood-style attacks are easily executed and are therefore popular amongst even unskilled hackers. Defences are not readily available, since an attack victim usually does not have control over the amount of traffic an attacker can produce. A victim might be able to put filters into effect as quickly as possible, but the problem often is that the target does not know whether it is under attack, or whether it just experiences unusually high network traffic for other, legitimate reasons.

A flood-style DoS attack may be performed by using remote hosts to generate unusually high volumes of network traffic and direct the data packets to a corporate site. The remote hosts generate such a high amount of information that the bandwidth of the communication channels and processing capabilities within the network hosting the corporate site become overloaded with invalid information. The effect of this is that no legitimate traffic can pass through the network. This leaves the network essentially inoperable, causing lost productivity, sales and frustration.

At present firewalls are typically unable to detect and deflect flood attacks. This is due to the data packets being transmitted to the network not having the traditional characteristics of other forms of attack such as viruses, Trojan horses and unauthorised access. A denial of service attack may also be generated from within the network, which cannot typically be detected using a firewall or a device monitoring solely incoming and outgoing communications.

Network resource exhaustion, which may be caused by non-malicious activities, for example an accidental network mis-configuration, or a sudden flash crowd to a site, may also result in similar effects as a flood style attack. Thus, handling these conditions is similarly of interest to the network operator.

In addition, worms and viruses continue to be a problem. Traditionally, the end-users are affected by these attacks, since their computers get infected. The network is merely a medium for a worm or virus to spread. But lately, even for the network operator this has become an important issue, especially considering that the rapid spread of recent worms has consumed massive amounts of network bandwidth, and therefore also causes flood-attack style symptoms.

Network operators are also faced with users who exploit their network usage plans in unforeseen manner, hogging extraordinary amounts of bandwidth on a flat fee, for example. The network operators need mechanisms to manage the bandwidth of their users and differentiate also between services of different value (for example, a financial transaction may need higher priority than web-browsing).

Many current network monitoring, traffic filtering, shaping, or re-directing systems, used to secure networks not only against attacks but also other conditions of accidental flooding or accidental or deliberate misuse, suffer from a lack of scalability, i.e., they are limited to relatively low bandwidth operations, thereby making it impossible for them to be effectively deployed by network operators, who typically deal with some of the highest bandwidth, multi-gigabit, links. Therefore, there is a need for scalable mechanisms.

It is an object of the present invention to provide a method, apparatus and/or software product for network communication security, which overcomes or alleviates problems in network security at present by providing a means to detect flood-style denial of service attacks.

A further or alternative object of the present invention is to provide a method, apparatus and/or software product for network communication security and allows for the implementation of a scalable platform for the deployment of security services.

A further or alternative object of the present invention is to provide the public with a useful alternative.

Further objects of the present invention may become apparent from the following description.

Definitions

Throughout this specification and accompanying claims, the word “attack” has been used with reference to the existence of conditions that may adversely affect the operation of a network. Without limitation, these conditions may include those that indicate that a denial of service attack may be occurring, a virus or worm has been received, or that a signature based attack may be occurring. The conditions may result with or without the presence of an actual malicious attack from inside or outside the network.

Therefore, the term “victim” has been used to describe a particular component of a communications network where an “attack” as defined above has been directed.

Also, throughout the specification and accompanying claims, the term “volume” when used with reference to volume of Information communicated has been used with reference to the depleting effect network communications have on network communication resources. Thus, the term volume is intended to include, for example, a measure of the number of packets communicated, regardless of their size. This is in addition to other measurements that may be bandwidth related, such as the number of bytes communicated.

The term “packet decision making device” has been used herein with reference to any device or combination of devices operable to identify individual packets within data traffic and selectively direct packets to one output and also perform one or both of the functions of removing selected packets from the data traffic and directing packets to one or more other outputs.

The term “smallest possible superset” or “SPSS” has been used in the sense of “one of the smallest” and is not necessarily the absolute smallest superset.

### SUMMARY OF THE INVENTION

In one aspect the invention provides a traffic evaluation device including a data interface to receive one or both of network traffic and data indicative of characteristics of network traffic and including processing means operable to evaluate the network traffic and/or data received by said data interface for predetermined characteristics that indicate that the network traffic contains a subset of attack traffic, and upon detection of said predetermined characteristics retrieve from memory information defining a superset and provide an output defining said superset, wherein the superset is a portion of the network traffic that contains said subset and defines network traffic that may be redirected and/or blocked by a network device.

In another aspect the invention provides a traffic evaluation device including a data interface to receive from a network device one or both of network traffic and data indicative of characteristics of network traffic and including processing means operable to separate the network traffic and/or data indicative of characteristics of network traffic received by said network interface into a plurality of groups and evaluate each group for predetermined characteristics that indicate that the group contains a subset of attack traffic.

In another aspect the invention provides apparatus for monitoring network traffic for a traffic profile abnormality, the apparatus including data volume observing means for observing the volume of data communicated to or within a network and data classification means for classifying data communicated to or within the network into one or more of a plurality of classes and a processing means operable to:
a) for at least one pair of classes compute a ratio of:
   observed data volume of one class or a function of observed data volume of one or more classes to
   observed data volume of another class or a function of observed data volume of one or more other classes;
b) evaluate whether the one or more ratios indicate abnormal network traffic against predetermined criteria and if so output either or both of a signal indicating the potential occurrence of an attack.

In a further aspect the invention provides a method of network traffic management including using a computer processing means to evaluate network traffic for predetermined characteristics that indicate that the network traffic contains a subset of attack traffic and upon detection of said predetermined characteristics retrieving from memory a superset, wherein the superset is a portion of the network traffic that contains said subset and defines network traffic that may be redirected and/or blocked by a network device and communicating said superset to the network device.

In a further aspect the invention provides a method of managing network traffic including using a processing means to separate network traffic received by a network device or data indicating characteristics of network traffic received by a network device of into a plurality of groups and evaluating each group for predetermined characteristics that indicate that the group contains a subset of attack traffic and upon detection of said predetermined characteristics, retrieving from a memory information defining a superset and communicating to a network device that receives the network traffic an output defining said superset, wherein the superset is a portion of the network traffic that contains said subset and defines network traffic that may be redirected and/or blocked by the network device.

In a further aspect the invention provides a method of monitoring network communication for a network traffic abnormality, the method including
a) observing the volume of data communicated to or within a network;
b) classifying data communicated to or within the network into one or more of a plurality of classes;
c) using a computer processing means, compute for at least one pair of classes a ratio of:
   observed data volume of one class or a function of observed data volume of one or more classes to
   observed data volume of another class or a function of observed data volume of one or more other classes;
d) evaluate whether the one or more ratios indicate abnormal network traffic against predetermined criteria and if so output either or both of a signal indicating the potential occurrence of an abnormality or instructions to a network device to take predetermined action in response to the abnormality.

In a further aspect the invention provides apparatus for monitoring network traffic for a traffic profile abnormality, the apparatus including historical traffic data gathering means to provide at least one selected normal traffic parameter, observing means for observing the current traffic data relating to the selected parameter to provide at least one current traffic parameter, and evaluating means to evaluate a deviation between the normal traffic profile parameter and the current traffic profile parameter against a threshold to determine whether a traffic abnormality exists.

In a further aspect the invention provides a method of monitoring network traffic for a traffic profile abnormality, the method including the steps of gathering traffic data to provide at least one selected normal traffic parameter, observing the current traffic data relating to the selected parameter to provide at least one current traffic parameter, and evaluating a deviation between the normal traffic profile parameter and the current traffic profile parameter against a threshold to determine whether a traffic abnormality exists.

Further aspects of the present invention, which should be considered in all its novel aspects, may become apparent from the following description, given by way of example only and with reference to the accompanying drawings.

### BRIEF DESCRIPTION OF DRAWINGS

FIG. 1: Shows a block diagram representation of a computer network including a network security/management apparatus according to one aspect of the present invention.

FIG. 2: Shows a block diagram the network security/management apparatus according to the present invention.

FIG. 3: Shows a functional diagram of the network security/management according to the present invention.

FIG. 4: Shows a possible network structure according to an aspect of the present invention, the network structure incorporating the network security/management apparatus of FIGS. 2 and 3.

FIG. 5: Shows a representation of data groups that may be communicated in a network and discriminated according to an aspect of the present invention.

### MODES FOR CARRYING OUT THE INVENTION

The present invention relates to methods, apparatus, and software for network communication security and management. Various characteristics of traffic destined for a network are monitored and traffic may be diverted from the network if it is identified as being invalid.

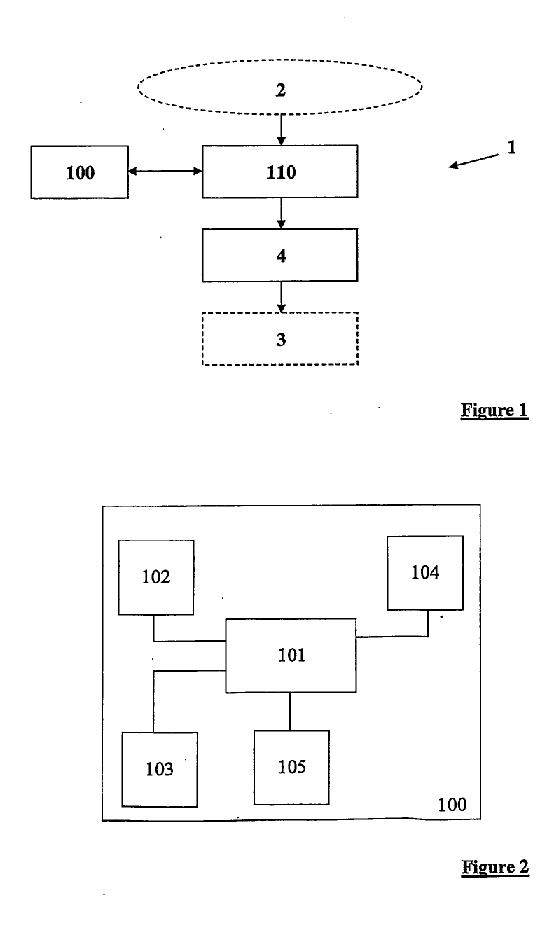

FIG. 1 shows a block diagram broadly showing a simplified communication network 1 including an apparatus 100 in accordance with an aspect of the present invention. The apparatus 100 may communicate with a router 110 or other packet decision making device that is positioned between a wide area network, for example the Internet 2 and a corporate network 3 that requires protection. The router 110 may be an existing router in the communication network 1 or added to the communication network 1 together with the apparatus 100. The corporate network 3 includes at its communication interface a firewall 4 for security purposes. In typical networked systems, the firewall forms the first and strongest line of defence to various forms of attack to the corporate network. In one embodiment of the invention shown in FIG. 1, at least one network security apparatus 100 and associated router 110 is located outside the firewall 4 so as to have immediate control over information communicated to the corporate network 3 through the firewall 4.

It will be appreciated by those skilled in the art that many variations are possible in the structure of a network, with the example in FIG. 1 provided for illustrative purposes only. For example, the Internet 2 may be replaced by an intranet, the corporate network 3 may be connected to numerous networks and/or have multiple access points, an apparatus 100 may be located behind the firewall 4 within the corporate network 3, and/or an apparatus 100 may be located between terminals, servers or other nodes in a network. In addition, an apparatus 100 may be placed at each of a plurality of locations. For clarity, the remainder of the description assumes that the apparatus 100 has been located outside the network.

FIG. 2 shows a block diagram of the main components of an apparatus 100. A processor 101, which may be microprocessor, digital signal processor, microcontroller or other device or combination of devices suitable for performing the processing functions of the present invention, is provided. A user interface 102 or other communication interface may be provided to allow reconfiguration of the apparatus 100 as required.

A memory 103 readable by the processor 101 contains information for use by the processor 101. The memory 103 contains the instructions governing the operation of the processor 101 and data relating to existing activities as well as historical data. The memory 103 may provide both a permanent and temporary storage function as required. The memory 103 may include information regarding what network traffic or data should be analysed, when it should be analysed and how it should be classified. In addition, the criteria against which the network traffic or data is compared may be stored in the memory 103. The memory 103 may include a separate database for historical data relating to network communications.

A data interface 104 is provided to allow the observation of data that is communicated to or within a network. As described above, the apparatus 100 may communicate with the router 110 to obtain the required information, in which case the data interface 104 includes a communication interface to receive communication signals from the router 110 using a predetermined communication protocol. In some embodiments, the data interface 104 may also send information to the router 110. A router has the advantage that it usually can, under the control of the apparatus 100, provide at least some of the filtering and redirection functionality described herein below. For those functions that the router 110 can not perform, the apparatus 100 may perform these functions, receiving network traffic through the data interface 104, performing the analysis and if required the filtering/redirect functionality to either block the received packets or forward the packets to an output through the data interface 104. The data interface 104 may forward packets back to the router 110. The apparatus 100 may thus direct the router 110 to direct only the portion of network traffic received by the router 110 that the router can not adequately analyse or filter/redirect/block.

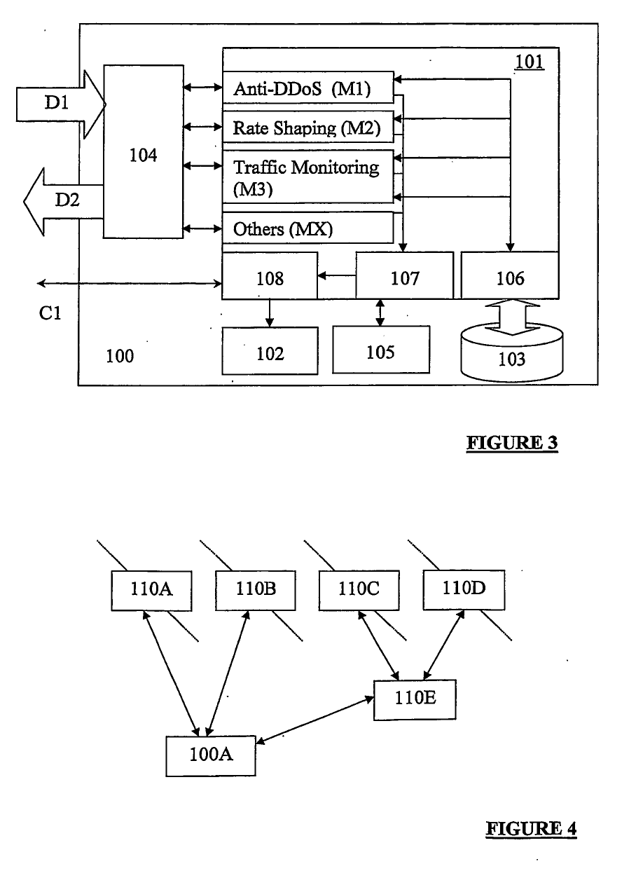

The apparatus 100 observes the communicated data. FIG. 3 shows diagrammatically some of the functions that an apparatus 100, in particular the processor 101, which it will be recalled may be more than one processing device, may perform. The data interface 104, which may optionally be integral with the processor 101, receives data from the router 110 (not shown in FIG. 3) as indicated by arrow D1, and sends any data that is to be returned to the router 110 as indicated by arrow D2. The data may include control or configuration information from the router 110 and/or network traffic redirected by the router 110 to the apparatus 100 for further filtering/redirection. The processor 101 has functional modules M1, M2 . . . MX, each assigned to certain functions. In the example shown in FIG. 3, the modules include functionality to detect and filter out attack traffic that forms part of a DDoS attack (module M1), a module for rate shaping (module M2), a module for traffic monitoring (module M3) and others as required for the particular network. An example of other modules that may be provided include virus and worm filters or content scanning and blocking functionality. The modules each evaluate data received and may implement filters to redirect or block particular packets dependent on the result of the evaluation and according to predetermined criteria. Those skilled in the relevant arts will appreciate that many different filtering strategies exist and more are continually being developed. An advantage of the present invention is that it is anticipated that future traffic evaluation/filtering/management modules may be relatively easily added to the apparatus 100.

The apparatus 100 may also include means to set static redirection instructions for the router. For example, a rule could be set that the first data packet from a client in an HTTP connection needs to be directed to the apparatus 100, so that it can be scanned for worm signatures.

Not only those traffic streams directed to a victim may be redirected, but also the traffic stream from a victim may be redirected. This may be required in rate-shaping applications, as some rate shaping techniques require control over the outgoing traffic as well, for example, for the re-writing of window sizes in TCP. In security applications, certain attacks can be detected when the response from the server is examined in detail, for example, the number of outgoing FIN packets vs. the number of incoming SYN packets. That is a ratio, which can indicate the presence of SYN attack and may be identified by the ratio analysis detailed herein below. An anti-virus or worm scanning application may also inspect outgoing traffic to see if a worm or virus spreads outwards.

While some redirects of the router 110 may always be active, for the others, which are based on some sort of condition, the redirects should have a fixed lifetime. A redirect may be left active for a predefined period and then automatically removed after it expires. A re-evaluation of the traffic may be performed at the time of expiry and if necessary, the filter may be reactivated if the attack is still going. Alternatively, or in addition, there may be an external form of notification, for example a software agent on an attacked victim machine that notifies that the filter is no longer required. The software agent may have requested the initiation of the filter in the first place. In a further alternative embodiment, the number of packets or connections filtered may be monitored. If it decreases to acceptable levels (a configurable parameter, for each kind of attack, or victim, or network link, or some combination of those and other factors), the redirect is stopped removed. Similarly, filters in modules M1-MX may either be always active or have a fixed lifetime.

The processor 101 may store and collect packets that have certain characteristics in common in order to process them as one union. For example, IP may fragment a packet in transit. The processor 101 may collect and if possible reassemble such fragments so that the entire fragmented original packet can be examined for signatures, or for purposefully ambiguous fragmentation, which is a well-known means to evade intrusion detection systems. Methods for reassembly of fragmented packets are well known and therefore will not be detailed herein. The apparatus 100 may also contain means to send these collected packets on through data interface 104 either individually in their fragmented state, or in the reassembled state.

In addition, the processor 101 may modify network packets in response to the detection of certain properties of packets. For example, the processor may remove ambiguity in fragmented packets, or overwrite signatures of worms, so that they are disabled and cannot infect clients. The apparatus 100 may then return the overwritten packets to the network, usually through router 110.

One function of the apparatus 100 may be to monitor for denial of service attacks, see module M1. To perform this function, the processor 101 obtains through the data interface 104 a measurement of the volume of network traffic being communicated to the corporate network 3 generally and/or to individual addresses within the corporate network. If a router is used, volume information can be collected, for example, by querying the router directly by automatically logging in via a SSH or Telnet session and retrieving the counter values, or by using SNMP to read that value, or by reading netflow (Cisco) or similar data from the router. Where there is already a suitable router or similar device suitable for at least observing network traffic, then the remainder of the apparatus 100 may be appended to this device. Alternatively, a customised device may be designed to select packets out of a packet stream. Persons skilled in the relevant arts will appreciate that there are a large number of ways to obtain information on data communications within a network.

Particular profiles of packet volume may be used to indicate certain communication types or conditions. The apparatus 100 may also observe the number of bytes contained in each packet or some other measure of packet size if required. Not every packet may be counted if other factors deem the packet to be uninteresting. For example, at a particular site in a network, protection may be required only against certain protocols such as unusually high volumes of UDP or ICMP packets. All TCP packets may be deemed to be valid traffic for that site. Other examples include if the data volume is monitored through a device that can keep track of ongoing TCP connections, packets of an already established connection may be ignored or if a specific IP address or specific router is considered ‘trusted’ then packets having that source address or coming from that router may not be considered. Those skilled in the art will recognise that many different options exist for varying what traffic is and is not monitored. However, those skilled in the art will also recognise that the selection of traffic that is not to be monitored must be undertaken with care so as to not make the network overly vulnerable.

The apparatus 100 compares the measure of volume acquired by the processor 101 against normal levels of communication stored in the memory 103, and a database communication management functions 106 are provided in the processor 101 for this purpose. If sufficiently abnormal conditions exist (as described herein below), the apparatus 100 may issue a warning or alert, which may be communicated by the apparatus 100 through a suitable communication interface 105. The communication interface 105 may be the same as the user interface 102 or may be a separate interface. The warning or alert may be displayed on a visual display device, an audible alarm may sound, the event may be simply logged in a log-file and/or a signal may be sent to another device for evaluation and action if required. The signal may be simply a single line going high or low, may be an email sent to a predetermined address or any other signal that communicates the warning or alert. A warning may be a passive indicator of some abnormal conditions, used to draw the attention of the system administrators to the abnormality, whereas an alarm may automatically trigger some further action, such as active filtering, as described in more detail herein.

The packets on one or more computer connections may be sampled, the sampling enforced either by the apparatus 100 or by a router or switch. The percentage of sampled packets may be 100% or less as required. Lesser percentages may be required to reduce the computational burden on the apparatus 100. The sample period and separation between samples may be configurable. Reconfiguration may be performed through the user interface 102. The configurable aspects of the apparatus 100 may be protected by a password and/or other security measures to ensure only authorised persons can reconfigure the apparatus 100.

After the apparatus 100 has observed network traffic communicated to a network, the processor 101 classifies each packet within the traffic into at least one class and increases a counter associated with that class. The classes that are made available depend on the analysis requirements for the network and may differ between networks and between sites. The apparatus 100 may be configurable to enable variation of the classes and the data packets that are included in each class. The router 110 may provide the counter values to the processor if it is able to do so. An interpreted, script-like language may be used if the processor 101 can accommodate such. Ten examples, a-j of possible classes are given below.

a. TCP packet

b. UDP packet

c. ICMP packet

d. TCP-SYN packet

e. TCP-FIN packet

f. TCP-RST packet

g. Packet longer than X bytes

h. Packet shorter than X bytes

i. Specific ICMP message type

j. Packet is IP-fragment

A single packet may fall within more than one class, in which case the counter of all classes in which it falls within may be incremented, or only selected counters may be incremented, for example based on a predefined rank.

A C-style pseudo-code example of how to implement a classification and counter for each class is given below:

```
if (new packet is received) {
    switch (IP protocol) {
    case TCP:  tcp_counter++;
                    break;
    case UDP:  udp_counter++;
                    break;
    case ICMP:  icmp_counter++;
                    break;
    default:  other_protocol_counter++;
                    break;
    }
    if (length of packet < 60) {
        short_packet_counter++;
    }
    else {
        long_packet_counter++;
    }
    ...
}
```

Those skilled in the art will recognise that modifications and improvements may be made to the classification algorithm.

The profile of network traffic communicated to the network may provide information on whether the traffic is valid. For example, the applicant believes that profile analysis is particularly advantageous for detecting denial of service attacks. Ratios can be defined between any two or more counters for the classes identified above. These ratios provide a means of establishing the traffic profile. Some examples of possible ratios, I-V are provided below.

I. Ratio of TCP packets vs. UDP packets

II. Ratio of-TCP-SYN packets vs. TCP-FIN packets

III. Ratio of short packets vs. long packets

IV. Ratio of UDP packets vs. ICMP packets

V. Ratio of IP fragments vs. non-fragmented packets

Those skilled in the art will recognise that any combination of classes may be used to define a ratio as required. The ratios may be selected to indicate the presence or absence of certain types of data in the communication monitored. The variables of a ratio need not be limited to one class, but may be a combination of classes. For example, two ratios may be summed, averaged or otherwise manipulated to form one variable of a ratio with another variable that may be a ratio, sum of ratios or other function of ratios. A ratio that may have particular application to web-sites is the ratio between TCP-SYN packets and the sum of TCP-FIN and TCP-RST packets. This ratio may be used to determine whether the network traffic profile is consistent with a SYN-flood attack.

To provide a point of comparison, observations of packets during normal communication periods may be made to form historical data. Alternatively, the values may be set independently of any measurements based on prior knowledge of what the communication profile normally is or should be. For example, traffic volume can be recorded during normal operation conditions in second or minute intervals over the duration of hours, days, and weeks, even months or years. The current network parameter, for example volume, can be compared to the stored historical data. If the current level deviates from the historical level by a certain extent, for example by a predetermined percentage, which preferably is a configurable value, a traffic anomaly is deemed to occur at this moment.

In a preferred embodiment, the historical information may be rolling, in that only the past few days, weeks or months may be stored. This ensures that the historical data remains current given normal changes in communication volumes and patterns over extended periods. To accommodate daily, weekly and monthly variations, the current measurements may be compared to the historical data obtained at multiples of days, weeks or months in the past. Even yearly variations may be accommodated if sufficient historical data is available. This comparison may be performed in addition to or instead of a comparison to average values. The resolution of historical data may be reduced as it gets older, for example by replacing multiple entries by a single average entry.

The historical information may be stored in simple tables in memory 103. By way of example, the tables may have the form shown in Table 1.

TABLE 1

| | <traffic-set> | <traffic-set> | <traffic-set> |
|---|---|---|---|
| <time-stamp-1> | <value> | <value> | <value> |
| <time-stamp-1> | <value> | <value> | <value> |

Where:
<time-stamp-1> indicates a time reference that is used to identify the appropriate historical data that should be retrieved for comparison with a measurement taken at a particular time. The time-stamp typically will indicate an averaging period, for example specifying a particular fifteen minute period.
<traffic-set> is a descriptor of the traffic subset, for example “all traffic to address a.b.c.d.” or “all traffic to port 80 from address a.b.c.d.”. The traffic subset may be more or less specific, such as “all TCP packets to address a.b.c.d” or “all TCP-Syn packets” or “all incoming ICMP echo requests”. The specification of the traffic subset may be achieved in the form of a regular expression such as filter expression of the Berkley Packet Filter (BPF).
<value> is the measured value of the traffic subset during the time indicated by the time-stamp, for example “the number of packets to address a.b.c.d.” or “the number of packets to port 80 from address a.b.c.d.”. Where the time-stamp indicates an averaging period, the value is the average value of samples of the traffic subset over that period. A typical sampling period for the traffic subset may be several minutes.

The information stored in tables such as Table 1 is extracted to form the current model for analysis purposes. In broad terms, the data indicative of normal traffic (which is preferably derived from historical traffic data and may also referred to as providing a “model”) is compared to the current measured traffic data values. The deviation between the model and the actual value is then normalized (as described in greater detail below), and the sum of all the deviations for an “attack vector” is calculated. If that sum, the detection factor (or degree of abnormality (da)) exceeds its thresholds (configurable on a per-attack-vector basis), then an alarm condition indicative of an abnormal traffic condition may exist.

Other variables than packet numbers, such as sub-sets of the traffic set, including number of bits may be included in the table if required and if the information is available from the router 110. The “tolerance” is not essential in Table 1 and may be replaced by a global tolerance level or if some other statistical measure indicates a variation of a certain degree. For example, the variation used in the ratio analysis herein described may be used instead of the per-traffic set tolerance described in relation to Table 1.

Although the formation of the historical data has been described in the context of detecting flood-style attacks, historical data may be collected in relation to the detection of other types of attack if comparison with past traffic characteristics is useful in detected those other types of attack.

After the normal ratios have been established using the historical data, they can be used as a factor to normalise the current ratios. As an alternative to ratios, counters or statistics may be used for example. This may be accomplished by dividing the current ratio by the normal ratio. After this normalisation step has occurred, the deviation, in form of variation or standard deviation can be computed for the complete set of ratios, either individually or in combination. The variation, standard deviation, or a similar statistical tool may be used to arrive at one value (or a small set of values), which describes the degree of abnormality for the current network traffic profile.

The deviation is computed for individual ratios and the result used to determine whether or not an alert or warning should be issued. The alert or warning may be in the form of instructions to the router 110 to start blocking particular packets or to start redirecting packets, for example to the apparatus 100, which will perform filtering on the packets. The value of the deviation that triggers and alert or warning is a user configurable aspect. Although analysing ratios may provide particular advantage in detecting abnormal traffic conditions, analysis of individual measurements may also be performed.

An additional measure of whether an attack is occurring may be obtained by computing the deviation of combinations of ratios, combinations of particular values, such as a count of a particular packet type or combinations of ratios and particular values. By using such combinations, particular communication profiles can be identified that may indicate the presence of absence of a denial of service attack. This ‘additional measure’ of using combinations, and a da computed over the deviations of multiple statistics and/or ratios, is the most preferred method of detecting attacks, since singular statistics are usually not accurate or telling enough.

For example, the variation, v of n ratios and values may be calculated as indicated by equation 1.

$$v = \frac{{\sum }_{1}^{n} {( 1 - \frac{{r}_{i}}{{r}_{i}^{′}} )}^{2}}{n - 1} \qquad equation 1$$

In equation 1, rᵢ is the current ratio or value, while rᵢ ′ is the ‘normal’ ratio or value. The standard deviation is simply the square root of the variation.

An example in pseudo-code for a case where the variation over the TCP/UDP ratio, the UDP/ICMP ratio and the TCP_SYN/TCP_FIN ratio is used is:
da=((1−tcp_{—}udp_ratio/normal_{—}tcp_{—}udp_ratio)\hat{ }2+(1−udp_{—}icmp_ratio/normal_{—}udp_{—}icmp_ratio)\hat{ }2+(1−syn_{—}fin_ratio/normal_{—}syn_{—}fin_ratio)\hat{ }2))/2;

An example in pseudo-code for the detection of so called “SYN-Flood” attacks, using the variation over the rate of receipt of SYN packets and ratio of SYN to FIN packets is:
da=((1−syn_rate/normal_{—}syn_rate)\hat{ }2+(1−syn_{—}fin_ratio/normal_{—}syn_{—}fin_ratio)\hat{ }2))/2;

To further fine-tune the calculation of the degree of abnormality (da), weights may be assigned to each of the ratios, so that a particular ratio may be given more importance than another. This can be achieved using equation 2.

$$da = \frac{{\sum }_{i}^{n} {( {w}_{i} ( 1 - \frac{{r}_{i}}{{r}_{i}^{′}} ) )}^{2}}{n - 1} \qquad equation 2$$

In equation 2, wᵢ is the weight of each ratio, rᵢ is the current value of a ratio and rᵢ′ is the ‘normal’ value of that same ratio.

An example of a weighted determination of the degree of abnormality in pseudo-code. is:
da=((tuw*(1−tcp_{—}udp_ratio/normal_{—}tcp_{—}udp_ratio))\hat{ }2+(uiw*(1−udp_{—}icmp_ratio/normal_{—}udp icmp_ratio))\hat{ }2+(sfw*(1−syn_{—}fin_ratio/normal_{—}syn_{—}fin_ratio))\hat{ }2))/2;
where tuw, uiw, and sfw are the weights assigned to the TCP/UDP ratio, the UDP/ICMP ratio and the TCP_SYN/TCP_FIN ratio respectively.

Thresholds can be specified for different alert levels. These thresholds may be customised for each site. For example, a warning may be issued by the processor 101 through the interface 105 if the standard deviation exceeds 0.3, an alarm issued if the standard deviation exceeds 0.6. The apparatus 100 may provide together with the warning or alarm details of the most deviating ratio or ratios. This information may be used by a system administrator to indicate the kind of attack that may be occurring. The system administrator may be a person, a computer or a combination thereof. A computer, which may be processor 101, may analyse the ratios and any other information that may be relevant to provide an indication of a possible form of attack and suggest or implement a suitable remedial action.

Known or expected variations in the volume values for certain times, can be identified in advance and the table entries varied manually to accommodate these. By way of example, if the tables are stored in ASCII format, a simple text editor can be used to edit them. The thresholds may be varied upon introduction of a new popular web page, download program or other change indicating an increase (or decrease) in communications.

It will be appreciated by those skilled in the art that other measures of deviation from normal communications may be used. The use of the standard deviation or variation of normalised ratios is only one example. Other methods of measuring deviation may be used for all or selected ratios or combinations of ratios.

For example, instead of using the variation, the degree of abnormality may be calculated using equation 3.

$$da = \sum {w}_{i} \frac{\vert r - {r}^{′} \vert}{{r}^{′}} \qquad equation 3$$

Equation 3 may provide the advantage that the differences in da are more proportional to the changes. Thus, the value of da will change more evenly, rather than first slow and then fast as with the variation. In addition, by using the actual value of-the numerator in equation 3 instead of the absolute value, both incoming and outgoing traffic is identified and can be analysed individually.

The processor 101 may issue a warning or alert only when selected combinations of ratios or values exceed their thresholds. The threshold of a combination occurs when their da exceeds its pre-specified thresholds. The da's are preferably calculated independently for each attack vector, and have independent thresholds. For a particularly important combination, an alert may issue immediately when its associated threshold is exceeded. For less important combinations, an alert or warning may issue only if thresholds of certain other ratios or combinations are also exceeded. Other variables may be used to control when a warning or alert, including, but not limited to using averaging to smooth the analysis over time and specifying a certain amount of time that alarm or warning conditions must exist before an alarm or warning is issued and specifying a time period after alarm or warning conditions have ceased before another alarm or warning is issued. These variables are user configurable.

As stated herein above, the apparatus 100 may be configurable to enable variation of the classes and the data packets that are included in each class. The ratios that are calculated and the threshold or combination of thresholds that indicate an attack may also be configurable if required. Such configuration may allow the present invention to effectively operate in a wide range of networks in a range of positions within a network.

In addition the thresholds may be variable dependent on the result of one or more predetermined ratio calculations. For example, a change in one ratio or average of ratios may result in a change of the threshold for another ratio. Thus, if the SYN-FIN ratio indicates a potential SYN-flood attack, then a different and stricter threshold may be used for TCP/ICMP ratio. Therefore, if one kind of attack occurs, the system becomes additionally sensitive to potential other forms of attack.

In a further embodiment, an expert system or learning system may be used to continually update the “normal” traffic profile. Thus, the thresholds for selected ratios and/or the weighting of ratios may be varied dependent on the expert or learning system. Such a system may monitor changes in the network profile over extended periods of time, longer than any anticipated attack could be spread over, to automatically update the thresholds to reflect the current communication content. Further, feedback may be provided from a system administrator when an alert or warning is issued whether there was actually an attack. The system may then learn over time patterns that indicate an attack and those that may have similarities to an attack but are actually caused by valid traffic.

While the ratios may be re-calculated with every received packet, CPU cycles may be saved for these otherwise CPU intensive calculations. This may be achieved by exploiting the fact that ratios should be computed on averages, in order to smooth the result. The averages are calculated only after the sampling period of the average has elapsed. So each average has a time-stamp associated with it, which indicates when the average needs to be recalculated. The interval between recalculation is a configurable attribute of each average. Also, with each average, the value of the counter at the last time of average calculation is stored.

A ratio only needs to be recalculated if at least one of the averages on which the ratio is based has been updated. One way to implement this is to associate with the average references to each ratio, which utilises this average. The apparatus 100 can then successively update each of these ratios only when needed. Other ways to accomplish this are easily conceivable to anyone skilled in the art.

An example implementation of the calculation of an average in pseudo-code, for example the tcp-packet per second average, is:

```
if (current_time >= next_tcp_average_calc_time) {
    tcp_average = (tcp_counter−old_tcp_counter)/
                        tcp_calc_interval;
    old_tcp_counter = tcp_counter;
}
```

Modifications for the calculation of the average exist, which may be used if required.

In an alternative embodiment, the ratios may be treated as percentages. This treatment may provide a way of thinking that is familiar to humans and also allow for the use of relatively fast integer arithmetic, while at the same time being equivalent to an actual ratio. For example, calculating the TCP to UDP ratio may be accomplished by:
tcp_{—}udp_ratio=udp_average*100/tcp_average;

The result is the percentage-wise ratio of average UDP packets per second compared to average TCP packets per second. The extent of deviation of individual percentage values and or combinations of percentage values from their normal values may be used to trigger a warning or alert in the same way as deviation from the ratios.

In a preferred embodiment of the invention, all data that makes up the traffic to the network 3 may not be analysed. Instead, a particular group of traffic may be selected and its volume monitored. For example and without limitation a group may be defined as “all traffic to address a.b.c.d” or “all TCP traffic from port 80 on address a.b.c.d and destined to address w.x.y.z and with a length of at least 60 bytes but not longer than 512 bytes”. Multiple groups may be monitored simultaneously and the groups may overlap. Ratios may be based on the groups of data. By way of example, one group of traffic may be data communicated to and from a web-server and another group of traffic the data communicated to and from a chat-server. The characteristics of data communicated within these groups are likely to be totally different and therefore separate historical data, ratios and thresholds are preferably recorded and analysed for each group. Where filtering is used for purposes other than reducing the effects of a flood-style attack, the characteristics that indicate abnormal communications are likely to vary significantly dependent on device, making it advantageous to group the traffic into classes for detection of other attacks also.

There are several measures of data volume, including the number of bits, bytes, files, handshake signals and the like. The present invention may be implemented by classifying and counting any of these measures where such counting and classification is deemed to provide useful information on the volume of communication and/or the profile of communication to a network. The data classes and the selected measure used for volume determination may depend on the particular network and/or the location of the apparatus 100.

The apparatus 100 may perform further evaluation of the network traffic communicated through the router 110 other than ratio analysis in order to determine whether abnormal communication conditions exist. The further evaluation may also be used to discriminate invalid traffic from the valid traffic, with the invalid traffic being discarded by the processor 101. For example, if there is a well-known bit pattern in the flood, which may occur if the flood generating tool does not randomize all aspects of the traffic header, signature based filtering can be performed, since that bit pattern would be an identifier for a flood packet Packets may also be discarded if the flood belongs to a protocol or service that is not offered, supported or desired by the victim.

Other modes of analysis are conceivable and will depend on the network environment and the particular flood.

If an attack is detected, for example through the ratio analysis described herein above, the apparatus 100 may start to evaluate the traffic being communicated through the router 110 and implement filters to reject invalid traffic. The processor 101 may instruct the router 110 to redirect all traffic to the processor 101 for evaluation. In some circumstances, the processor 101 may instruct the router 110 to block all traffic it receives, or implement filtering itself, or forward a group of data or another subset of traffic to the processor 101. The processor 101 may then redirect valid traffic back to the router 110 for forwarding to the corporate network 3 and discard invalid traffic. The processor 101 may therefore also act as a filter for network data.

One way to filter traffic is to limit the traffic on the address, and/or port, and/or protocol that has been identified as being the target of an attack. Various types of information may be used to identify what data to filter including statistical analysis and a priori knowledge of the various types of attack and the data packets that form the attack. If the group of data analysed is sufficiently specific, for example specifying only data to a particular host, then the entire group may be filtered out. Legitimate clients will retransmit, so that their legitimate packets have a higher chance of getting through. This kind of rate limiting will reduce the impact of the packet flood on the rest of the network and further network elements. For example, if 50% of all incoming SYN packets are discarded on a random basis (because a SYN flood that doubles the volume of SYN packets has been detected),. and a client retransmits after 1 second, after 3 seconds and after 8 seconds, then each of these legitimate SYN packets is dropped with a 50% chance. Thus, the client will not get through with a 50% chance on the first attempt, with 50%*50%=25% on the second attempt (after 1 second), 50%*50%*50%=12.5% on the third try (after 3 seconds) and 50%*50%*50%*50%=6.25% after the fourth try (after 8 seconds). In other words, the client has a 93.25% chance that within 8 second he will connect successfully, even though 50% of all SYN packets have been dropped. If a SYN flood is detected, SYN-cookies may be generated or the apparatus 100 may act as a proxy on the application level.

Through observing communicated data at a plurality of points using one or more of the apparatus 100 located as required, an entire subnet or section of a network may be monitored. Each observation site may have its own rules for classifying and counting the data, may compute varying sets of ratios and have different thresholds. A diagrammatic representation of a communication system 10 having multiple observation points is shown in FIG. 4. In the embodiment shown in FIG. 4, a single apparatus 100A analyses the observed data from the routers 110A-110E. More than one apparatus 100 may be provided if required, with each apparatus 100 in communication with one or more routers 110. In FIG. 4, the dashed lines represent normal data flow to or from a network or to or from nodes within a network. By having multiple observation points, overall traffic ratios and statistics within the subnet or section of the network may be monitored. Furthermore, ratios and statistics for the traffic directed to specific servers or groups of servers, or originating from specific clients or groups of clients may be calculated and compared to predetermined ratios for determining if they indicate an attack. The ratios or statistics within each group may be calculated and/or the ratios or statistics across different observation points or groups of observation points may be computed and compared to thresholds.

Having a single apparatus 100 A evaluating the data at multiple observation points may be particularly advantageous. In many modern networks the traffic is routed in an asymmetric matter. That means that for example incoming packets of a connection travel a different path (and will traverse a different switching means) than outgoing packets. Likewise, traffic paths may change even in the middle of a connection. Therefore, by having all the paths evaluated by one evaluation means, the problem of asymmetric routing (the fact that not all the packets for the proper processing and monitoring of a connection are guaranteed to be visible at a given point) can be overcome. Even if more than one apparatus 100 is used, but still a relatively small number, per-connection information can be communicated between the relatively few apparatus 100.

Multiple apparatus 100 for a single switching means may be provided in some embodiments if required in order to have the power available to handle a large stream In detail. Well-known load-balancing techniques may be used to regulate the activities of each apparatus 100.

Thus a high level of flexibility is provided in how a network may be analysed. This may reflect the very different nature of communications existing between networks and between different parts of the same network.

Previous attempts to evaluate and filter network data have applied filtering and redirection to the entirety of the data. This is resource intensive and limits the scalability of the system. By selecting only a portion of the traffic for analysis, the scalability of the apparatus 100 may be improved. It will be recalled that the apparatus 100 of the present invention may analyse groups of traffic for detection of abnormal traffic characteristics. This may increase accuracy and speed in traffic evaluation. In a preferred embodiment, the apparatus 100 applies filtering to only a selected portion of the traffic.

The functionality of the processor 101 to perform this selection is represented by box 107 in FIG. 3. Each module M1-MX may only require a sub-set of the total traffic to be monitored. According to an aspect of the present invention, the processor 101 identifies a superset that contains the subset. The superset is still only a portion of the overall traffic, but is typically larger than the subset due to limitations in the capability of network devices such as routers. Preferably, the processor 101 attempts to identify the smallest possible superset “SPSS” that still contains the subset. Each module may have a corresponding SPSS, with the subset and hence the SPSS varying dependant on the particular abnormal traffic characteristics detected. The processor 101 may identify the SPSS for the particular router with which it is controlling as the union of the SPSS's of each active module M1-MX. The processor 101 communicates the required control signals to the router 110 (not shown in FIGS. 2 or 3) through control line C1.

The selected SPSS can then be filtered in additional stages. The extent to which data can be discriminated will affect how the apparatus 100 can define the SPSS. For example, if a web-hoster hosts twenty web-sites and one of these sites is attacked, say by a flood attack, the router could only select out the traffic to the attacked site, and leave all other traffic alone. Furthermore, if the router is capable, it may select specific traffic to the victim only. For example, if the victim is under SYN-flood on port 80, the switching means should select only packets for which a filter like the one provided immediately below would evaluate to TRUE:
source_address==victim_address AND
destination_port==80 AND
protocol==TCP AND
TCP-flags==SYN

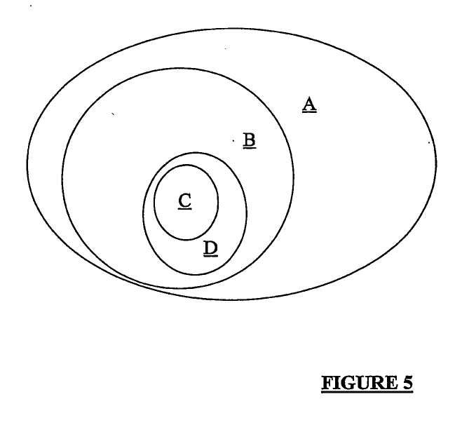

FIG. 5 shows a graphical representation of the SPSS, with different areas representing sets of data. Area A indicates the total amount of data handled by a router, which is part of the data interface 104. Area B indicates the total traffic, valid and invalid, directed to a specific victim of a flood attack and area C indicates the invalid traffic comprising the attack. The router is used, under the control of the processor 101 to direct a superset of the attack traffic, preferably the SPSS, indicated by area D to the processor 101. By only diverting the SPSS of the attack traffic, the impact on the overall network operation is minimised. This may be particularly important in environments where a large majority of the overall traffic is directed to just one ‘victim’, for example in the case of a large website, in which usually all traffic is directed to just one (or a small set) of IP addresses. Also, some of the signature-based filtering requires a Jot of CPU. If most of the traffic to a victim would have to be handled, the load may be too much for the filtering device.

The SPSS is the smallest set of traffic that the switching means is able to isolate, and which still contains the attack traffic (or flood traffic, or traffic that needs to be examined, or rate shaped, etc.) in its entirety. The process for identifying the SPSS is illustrated in FIG. 5.

The specification of the SPSS will vary dependent on filtering capabilities of the router 110. Therefore, as a first step to identifying the SPSS, a formal description of the capabilities of the router 110 or other switching means is formed.

The second step is to translate the filter request into that same formal description in order to allow the filter capabilities to be matched to the filter request. The third step is to find the set of filters on the router that most closely matches the filter request and still contains it in its entirety, and the fourth step is to translate the findings into specific instructions, specific for the particular router. There may be multiple routers 110, so the same SPSS filter may be represented multiple times in the format of different routers or switching means. The functions of the processor 101 to perform the second the third steps are represented in FIG. 3 by box 108.

In a network structure like that shown in FIG. 4, multiple routers 110 may send their SPSS to a single evaluation means. In another embodiment, the SPSS from one router or other switching means can be switched (narrowed down) by another router or other switching means. Multiple such layers may exist.

The capabilities of the router 110 or other switching means can be represented in the form of a table, an example of which is shown in table I in which the different capabilities are listed across the top, and the different routers down the side. In each row then, the combination of filtering criteria that is legal is identified.

TABLE 1

| | | | | IP- | | | | |
|---|---|---|---|---|---|---|---|---|
| | IP-src- | IP-dst- | IP- | pkt- | Src- | Dst- | TCP-window- | |
| | address | address | protocol | length | port | port | size | TCP-flags |
| Router_1 | Yes | Yes | Yes | | Yes | Yes | | Yes |
| Router_1 | Yes | Yes | | Yes | Yes | Yes | | |
| Router_1 | Yes | Yes | | | | | Yes | Yes |
| Switch_1 | Yes | | | | | | | |
| Switch_2 | Yes | Yes | Yes | | | | | |
| Switch_2 | Yes | Yes | | Yes | | | | |
| Router_2 | Yes | Yes | Yes | | | Yes | | |

A device can have multiple entries in the table. No entry for a given device is a proper subset of another entry for the same device, i.e. if a device can filter src-address AND destination-address together, it can do so also for each of them individually. In that case, it is enough to have one entry that lists both of these filter criteria together.

It may be possible for internal architectural reasons that a particular switch or router may only be able to switch on three elements total, even though there are four different kinds of elements to choose from. So, there would be four different combinations of three. Since none of those combinations is a subset of the other, they all would have to be listed in the table.

The filter request can come in the form of bit-patterns, a regular expression or an algorithmic expression. A parser checks whether any of the filter expression elements in table 1 are accessed in the filter request. If so, this is recorded in a bit vector, which is held in the same format as a table entry. For example, if the filter request looks like: “all packets with the destination address a.b.c.d and where the protocol is TCP and where the destination port is 80”, then the parser will recognise that “destination IP address”, “protocol” and “destination port” are utilised. An example filter vector in table format is shown in table 2.

TABLE 2

| | IP- | IP- | | | | | TCP- | |
|---|---|---|---|---|---|---|---|---|
| | src- | dst- | | | | | win- | |
| | ad- | ad- | IP- | IP-pkt- | | Dst- | dow- | TCP- |
| | dress | dress | protocol | length | Src-port | port | size | flags |
| Filter | No | Yes | Yes | No | No | Yes | No | No |
| Vector | | | | | | | | |

The next step is to find the most closely matching SPSS expression on a given route. By way of example, if the closest matching (but still inclusive) SPSS on all the devices listed in table 1 is required, the SPSS is identified by combining the filter vector with the individual entries via a logical AND operation. Only if the result of the AND operation is not FALSE in all columns is this device even capable of performing filtering on a SPSS of that filter vector. In this particular example, all devices, except ‘Switch_{—}1’ can form an SPSS. In that case, Switch_1 may have to direct all of its traffic to the evaluation means. Alternatively, if the network structure allows Switch_1 could direct its traffic to any one of the other routers or switches listed in table 1, with the other switch or router directing the SPSS to an apparatus 100.

All devices other than Switch_1 have the capability to select on at least one of the criteria of the filter vector a sub-set out of the overall traffic that forms an SPSS for the filter request. If multiple matches exist for a given device, the row in which most of the filter vector fields are matched is selected. For example, for Router_1 the first row is preferred over the second row, since the first row matches in all three elements of the filter vector, while the second row only matches in two. The more of the filter vector elements that are matched, the smaller the SPSS will be. If the same number of matches exists in different rows of the table, then other criteria are used to select the appropriate SPSS. For example, some criteria may be known to select a smaller set of traffic (for example, if the source port in client requests is known, that is always much more specific than the destination port, since the destination port will be the same for all connections, while the source port is different for every single one). Other criteria may concern the filtering performance. All of this can be combined in a priority list for each device. For example:
Router_1: src-addr>src-port>pkt-len>win-size>dst-port>dst-addr>tcp-flags>protocol

There may be different priority lists for different routers/switches. Selection may be achieved simply by assigning a higher score to the ‘greater’ elements in the priority list and adding up those scores. The score leader is then the candidate SPSS filter. Once the SPSS filter has been identified, the values from the original filter request are assigned to those criteria (those that the device can actually express); resulting in a generic expression of what that SPSS filter should look like on that device.

The last step is to translate the filter request, which is the request to filter out the identified SPSS, into the actual commands for implementation of that filter on the router 110, switch or other device. There are several methods to achieve this, for example, constructing individual statements out from the filter elements. One suitable method is to simply store a template of the filter commands for each row in table 1. This template contains the complete command sequence, except the actual values on which to check and filter. So, when these values, for example the actual destination IP address, are extracted out of the original filter request, they just need to be inserted into the command template that is stored in the selected table row. The commands may then be applied to the router via Telnet, SSH or other protocol supported by the router.

There are several methods of specifying the re-direction of an SPSS from a switching means like a router. If the switching means is a router, for example, BGP (Border Gateway Protocol) may be used in order to affect the routing/filtering. With BPG only SPSSs based on the destination address are possible. Alternatively, a policy based routing/filtering (in case of Cisco) may be used, for which the evaluation means would log into the router (via Telnet or SSH, for example) and issue certain shell commands to the router, setting up specific routing policies for specific types of packets. In the case of Juniper, ‘Filter Based Forwarding’ may be used to specify the filter criteria.

The evaluation means may instruct the switching means to perform filtering, rather than just redirection, if the SPSS is actually exactly the sub-set that is to be filtered out. In that case, there is no point redirecting anything, the router or switching means can dispose of all data in the SPSS.

The router 110, in combination or under the control of an apparatus 100 may perform further functions for the management and security of network communications. For most network management and security functions it is anticipated that the router would have insufficient capability to perform the required function. Therefore, the router 110 directs the required traffic to the apparatus 100, which performs the necessary processing, filtering and/or modification of traffic and forwards it back to the router 110, which when forwards the traffic on to its destination. Where the router 110 or other switching means can perform these functions itself, the need for redirection of traffic to the apparatus 100 may be avoided.

The switching means may also be capable of performing rate limiting, traffic monitoring and rate shaping. Rate limiting, which is the dropping of a certain percentage of packets of a traffic stream, or rate shaping, which is the modifying of packets in such a way that a connection may slow down or speed up may be performed in order to implement specific QoS policies.

In addition, the apparatus 100 may include means to generate packets, such that for example a network connection can be interrupted by sending an RST packet (in case of TCP) to a server, when it was detected that a worm intended to use this connection for infection and spreading. TCP is just one example, and interrupting the connection is just one example. Packets can also be generated in order to send notifications somewhere, for example.

In the foregoing description, the apparatus 100 has been described In communication with a packet decision making device. In an alternative embodiment, the apparatus 100 may passively observe the data, in that it may not interfere with communications, just issuing alerts, warnings or the like based on the communications. In this embodiment, a passive device may be used instead of an active packet decision making device, and a router, switch or other packet decision making device located further downstream of the passive device. Devices that may be used in this passive embodiment for counting the number of packets destined for the network 3 include a hub, a network ‘tap’, fibre splitter, configuring a spanning or mirroring port on a router or switch, or by simply reading the packet counters from already existing routers. Those skilled in the relevant arts will appreciate that alternative methods and devices for observing data may exist. A packet decision making device downstream of the passive device may be controlled by the apparatus 100 or other controller that is in communication with the apparatus 100. Alternatively, network administrators may implement filters or the like in response to an alert or warning issued from the apparatus 100.

In another alternative embodiment, the router 110 or other device may be removed and the apparatus 100 may be located directly in the communication path and perform any filtering and redirection itself. In this embodiment, the data interface 4 is a data communication path in the network.

Where in the foregoing description reference has been made to specific components or integers of the invention having known equivalents then such equivalents are herein incorporated as if individually set forth.

Although this invention has been described by way of example and with reference to possible embodiments thereof, it is to be understood that modifications or improvements may be made thereto without departing from the scope of the invention as defined in the appended claims.

1. A traffic evaluation device including a data interface to receive one or both of network traffic and data indicative of characteristics of network traffic and including processing means operable to evaluate the network traffic and/or data received by said data interface for predetermined characteristics that indicate that the network traffic contains a subset of attack traffic, and upon detection of said predetermined characteristics retrieve from memory information defining a superset and provide an output defining said superset, wherein the superset is a portion of the network traffic that contains said subset and defines network traffic that may be redirected and/or blocked by a network device.

2. The traffic evaluation device of claim 1, wherein said output is in communication with the network device.

3. The traffic evaluation device of claim 1 wherein said data interface is adapted to receive data from a plurality of network devices.

4. The traffic evaluation device of claim 3 wherein and the processing means provides an output in communication with each network device capable of communicating a superset for the network device.

5. The traffic evaluation device of claim 4 wherein the operation of said processing means to evaluate data received by said data interface for the presence of predetermined characteristics in said network traffic includes considering data from two or more network devices together.

6. The traffic evaluation device of claim 1 wherein said data interface is further operable to receive network traffic from said network device, and dependent on any predetermined characteristics detected apply one or more filters to said network traffic to create filtered traffic and output said filtered traffic.

7. The traffic evaluation device of claim 1 wherein said data interface is adapted to receive data from at least a first network device and a second network device and the processing means is operable to retrieve information defining the capabilities of said first and second network devices and if a smaller superset can be achieved by the second network device on data received by the first network device, provide on its output to the first network device instructions that cause it to forward traffic received by it to a second network device and instruct the second network device to redirect and/or block and/or filter the network traffic received from the first network device that is defined by the superset.

8. The traffic evaluation device of claim 1 wherein the processing means is further operable to identify and assemble together packet fragments into a single packet and evaluate the assembled packet against said predetermined characteristics.

9. The traffic evaluation device of claim 1, wherein the predetermined characteristics include the existence of network traffic having predefined ratios of packets.

10. The traffic evaluation device of claim 1 wherein the predetermined characteristics include a deviation between one or more current traffic parameters and one or more normal traffic parameters.

11. The traffic evaluation device of claim 1, wherein the processing means is operable to identify groups of data in said network traffic and evaluate each said group for said predetermined characteristics, wherein the predetermined characteristics used are dependent on the group.

12. The traffic evaluation device of claim 9, wherein the processing means is operable to identify groups of data in said network traffic and evaluate each said group for said predefined ratios, wherein the predefined ratios used are dependent on the group.

13. A traffic evaluation device including a data interface to receive from a network device one or both of network traffic and data indicative of characteristics of network traffic and including processing means operable to separate the network traffic and/or data indicative of characteristics of network traffic received by said network interface into a plurality of groups and evaluate each group for predetermined characteristics that indicate that the group contains a subset of attack traffic.

14. The traffic evaluation device of claim 13, wherein upon detection of said predetermined characteristics, the processing means is further operable to retrieve from memory information defining a superset and provide an output defining said superset, wherein the superset is a portion of the network traffic that contains said subset and defines network traffic that may be redirected and/or blocked by a network device.

15. Apparatus for monitoring network traffic for a traffic profile abnormality, the apparatus including data volume observing means for observing the volume of data communicated to or within a network and data classification means for classifying data communicated to or within the network into one or more of a plurality of classes and a processing means operable to:
a) for at least one pair of classes compute a ratio of:
observed data volume of one class or a function of observed data volume of one or more classes to
observed data volume of another class or a function of observed data volume of one or more other classes;
b) evaluate whether the one or more ratios indicate abnormal network traffic against predetermined criteria and if so output either or both of a signal indicating the potential occurrence of an attack.

16. Apparatus as claimed in claim 15 wherein the processing means provide instructions to a network device to take predetermined action in response to an attack.

17. Apparatus as claimed in claim 15 wherein the traffic profile abnormality includes a denial of service attack.

18. The apparatus of claim 15, wherein the processing means is further operable to compute at least one degree of abnormality, the or each degree of abnormality being a weighted function of one or more ratios and wherein each degree of abnormality is one of the one or more ratios that is evaluated in step b).

19. The apparatus of claim 15, wherein the processing means is further operable to upon detection of an attack retrieve from memory information defining a set of data that contains the attack traffic and provide an output defining said set defines network traffic that may be redirected and/or blocked by a network device.

20. The apparatus of claim 15 wherein the processing means is further operable to identify and assemble together packet fragments into a single packet and evaluate the assembled packet against said predetermined criteria.

21. A method of network traffic management including using a computer processing means to evaluate network traffic for predetermined characteristics that indicate that the network traffic contains a subset of attack traffic and upon detection of said predetermined characteristics retrieving from memory a superset, wherein the superset is a portion of the network traffic that contains said subset and defines network traffic that may be redirected and/or blocked by a network device and communicating said superset to the network device.

22. The method of claim 21 including evaluating for predetermined characteristics network traffic from two or more network devices together.

23. The method of claim 21 wherein upon detection of said predetermined characteristics the method further includes directing said network device to redirect certain traffic to the computer processing means, and using the computer processing means to apply one or more filters to said network traffic to create filtered traffic and return said filtered traffic to the network device.

24. The method of claim 21 wherein the predetermined conditions include the existence of network traffic having predefined ratios of packets.

25. The method of claim 21 further including using the processing means to identify groups of data in said network traffic and evaluating each said group for said predetermined characteristics, wherein the predetermined characteristics used are dependent on the group.

26. The method of claim 24 further including using the processing means to identify groups of data in said network traffic and evaluate each said group for said predefined ratios and wherein the predefined ratios used are dependent on the group.

27. A method of managing network traffic including using a processing means to separate network traffic received by a network device or data indicating characteristics of network traffic received by a network device of into a plurality of groups and evaluating each group for predetermined characteristics that indicate that the group contains a subset of attack traffic and upon detection of said predetermined characteristics, retrieving from a memory information defining a superset and communicating to a network device that receives the network traffic an output defining said superset, wherein the superset is a portion of the network traffic that contains said subset and defines network traffic that may be redirected and/or blocked by the network device.

28. A method of monitoring network communication for a network traffic abnormality, the method including
a) observing the volume of data communicated to or within a network;
b) classifying data communicated to or within the network into one or more of a plurality of classes;
c) using a computer processing means, compute for at least one pair of classes a ratio of:
observed data volume of one class or a function of observed data volume of one or more classes to
observed data volume of another class or a function of observed data volume of one or more other classes;
d) evaluate whether the one or more ratios indicate abnormal network traffic against predetermined criteria and if so output either or both of a signal indicating the potential occurrence of an abnormality or instructions to a network device to take predetermined action in response to the abnormality.

29. The method of claim 28 further including using said computer processing means to compute at least one degree of abnormality, wherein the or each degree of abnormality is a weighted function of one or more ratios and evaluating the degree of abnormality as one of said one or more ratios.

30. The method of claim 28 wherein the step of monitoring for a network traffic abnormality includes the step of monitoring for a denial of service attack.

31. Apparatus for monitoring network traffic for a traffic profile abnormality, the apparatus including historical traffic data gathering means to provide at least one selected normal traffic parameter, observing means for observing the current traffic data relating to the selected parameter to provide at least one current traffic parameter, and evaluating means to evaluate a deviation between the normal traffic profile parameter and the current traffic profile parameter against a threshold to determine whether a traffic abnormality exists.

32. Apparatus as claimed in claim 31 wherein the selected parameter includes a plurality of parameters.

33. Apparatus as claimed in claim 32 wherein the evaluating means evaluates a-weighted sum of the deviations.

34. A method of monitoring network traffic for a traffic profile abnormality, the method including the steps of gathering traffic data to provide at least one selected normal traffic parameter, observing the current traffic data relating to the selected parameter to provide at least one current traffic parameter, and evaluating a deviation between the normal traffic profile parameter and the current traffic profile parameter against a threshold to determine whether a traffic abnormality exists.

35. A method as claimed In claim 34 including the step of selecting a plurality of parameters.

36. A method as claimed in claim 35 including the step of evaluating a weighted sum of the deviations.

37. Any novel feature or combination of features disclosed herein.
